(19) United States
(12) Patent Application Publication
(10) Pub. No.: US 2025/0301282 A1
(43) Pub. Date: Sep. 25, 2025

(54) MULTICAST AND BROADCAST CONFIGURATION SIGNALING

(71) Applicant: TOYOTA JIDOSHA KABUSHIKI KAISHA, Toyota-shi (JP)

(72) Inventor: Alireza BABAEI, Fairfax, VA (US)

(73) Assignee: TOYOTA JIDOSHA KABUSHIKI KAISHA, Toyota-shi (JP)

(21) Appl. No.: 19/233,681

(22) Filed: Jun. 10, 2025

Related U.S. Application Data
(63) Continuation of application No. 18/043,688, filed on Mar. 1, 2023.
(60) Provisional application No. 63/073,732, filed on Sep. 2, 2020.

(51) Int. Cl. H04W 4/06; H04L 5/00; H04W 72/231

(52) U.S. Cl. CPC H04W 4/06; H04L 5/0053; H04W 72/231

(57) ABSTRACT

A system, method and apparatus for mobile communications is provided. A user equipment (UE) receives one or more messages that include configuration parameters indicating that one or more multicast broadcast services are associated illustratively with a first control resource set (CORESET) and a first bandwidth part (BWP). The messages also include one or more first radio network temporary identifiers (RNTIs) associated with the one or more multicast broadcast services. The UE then receives via the first CORESET or the first BWP downlink control information associated with the one or more first RNTIs. The UE then received one or more transport blocks associated with the one or more multicast broadcast services.

### TECHNICAL FIELD

The disclosure relates to a wireless communication method.

### BACKGROUND ART

Generally described, computing devices and communication networks can be utilized to exchange information. In a common application, a computing device can request/transmit data with another computing device via the communication network. More specifically, computing devices may utilize a wireless communication network to exchange information or establish communication channels.

Wireless communication networks can include a wide variety of devices that include or access components to access a wireless communication network. Such devices can utilize the wireless communication network to facilitate interactions with other devices that can access the wireless communication network or to facilitate interaction, through the wireless communication network, with devices utilizing other communication networks.

### SUMMARY OF INVENTION

One of embodiments of the invention is a wireless communication method. The wireless communication method comprises: receiving, by a user equipment (UE), one or more messages comprising: configuration parameters indicating that one or more multicast broadcast service is associated with at least one of: a first control resource set (CORESET); and a first bandwidth part (BWP); and one or more first radio network temporary identifiers (RNTIs) associated with the one or more multicast broadcast services; receiving, by the UE, downlink control information associated with the one or more first RNTIs; and receiving, based on the downlink control information, one or more transport blocks associated with the one or more multicast broadcast service.

### BRIEF DESCRIPTION OF DRAWINGS

FIG. 1 shows an example of a system of mobile communications according to some aspects of one or more exemplary embodiments of the present disclosure.

FIG. 2A and FIG. 2B show examples of radio protocol stacks for user plane and control plane, respectively, according to some aspects of one or more exemplary embodiments of the present disclosure.

FIG. 3A, FIG. 3B and FIG. 3C show example mappings between logical channels and transport channels in downlink, uplink and sidelink, respectively, according to some aspects of one or more exemplary embodiments of the present disclosure.

FIG. 4A, FIG. 4B and FIG. 4C show example mappings between transport channels and physical channels in downlink, uplink and sidelink, respectively, according to some aspects of one or more exemplary embodiments of the present disclosure.

FIG. 5A, FIG. 5B, FIG. 5C and FIG. 5D show examples of radio protocol stacks for NR sidelink communication according to some aspects of one or more exemplary embodiments of the present disclosure.

FIG. 6 shows example physical signals in downlink, uplink and sidelink according to some aspects of one or more exemplary embodiments of the present disclosure.

FIG. 7 shows examples of Radio Resource Control (RRC) states and transitioning between different RRC states according to some aspects of one or more exemplary embodiments of the present disclosure.

FIG. 8 shows example frame structure and physical resources according to some aspects of one or more exemplary embodiments of the present disclosure.

FIG. 9 shows example component carrier configurations in different carrier aggregation scenarios according to some aspects of one or more exemplary embodiments of the present disclosure.

FIG. 10 shows example bandwidth part configuration and switching according to some aspects of one or more exemplary embodiments of the present disclosure.

FIG. 11 shows example four-step contention-based and contention-free random access processes according to some aspects of one or more exemplary embodiments of the present disclosure.

FIG. 12 shows example two-step contention-based and contention-free random access processes according to some aspects of one or more exemplary embodiments of the present disclosure.

FIG. 13 shows example time and frequency structure of Synchronization Signal and Physical Broadcast Channel (PBCH) Block (SSB) according to some aspects of one or more exemplary embodiments of the present disclosure.

FIG. 14 shows example SSB burst transmissions according to some aspects of one or more exemplary embodiments of the present disclosure.

FIG. 15 shows example components of a user equipment and a base station for transmission and/or reception according to some aspects of one or more exemplary embodiments of the present disclosure.

FIG. 16 shows an example multicast broadcast service (MBS) interest indication process according to some aspects of one or more exemplary embodiments of the present disclosure.

FIG. 17 shows an example MBS control signaling and traffic channel transmission according to some aspects of one or more exemplary embodiments of the present disclosure.

FIG. 18 shows an example process in MBS delivery according to some aspects of one or more exemplary embodiments of the present disclosure.

FIG. 19 shows an example MBS control signaling and traffic channel transmission according to some aspects of one or more exemplary embodiments of the present disclosure.

FIG. 20 shows an example process according to some aspects of one or more exemplary embodiments of the present disclosure.

FIG. 21 shows an example process according to some aspects of one or more exemplary embodiments of the present disclosure.

### DESCRIPTION OF EMBODIMENTS

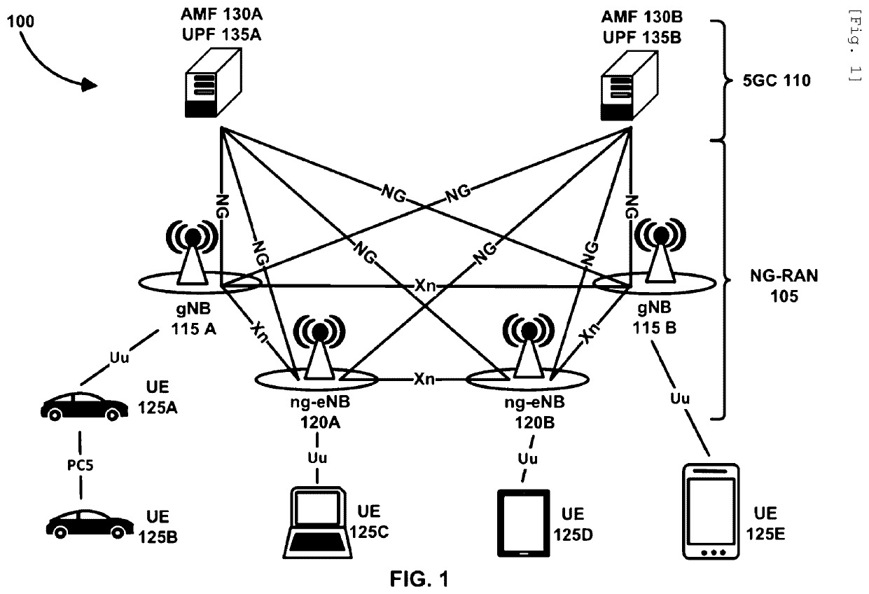

FIG. 1 shows an example of a system of mobile communications 100 according to some aspects of one or more exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 (e.g., UE 125A-UE 125E) and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UEs 125 and the RAN (e.g., the NG-RAN 105) may be referred to as Access Stratum (AS) and the functional layer between the UEs 125 and the core network (e.g., the 5GC 110) may be referred to as Non-access Stratum (NAS).

The UEs 125 may include wireless transmission and reception components for communications with one or more nodes in the RAN, one or more relay nodes, or one or more other UEs, etc. Example of the UEs 125 include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for the UEs 125 such as a Mobile Station (MS), terminal equipment, terminal node, client device, mobile device, etc. Still further, the UEs 125 may also include components or subcomponents integrated into other devices, such as vehicles, to provide wireless communication functionality with nodes in the RAN as described herein. Such other devices may have other functionality or multiple functionalities in addition to wireless communications.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 (e.g., gNB 115A, gNB 115B) or a next generation evolved Node B (ng-eNB) 120 (e.g., ng-eNB 120A, ng-eNB 120B). In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and General Packet Radio Service (GPRS) Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 (e.g., AMF 130A, AMF 130B) of the 5GC 110 by means of the NG-C interface and to a User Plane Function (UPF) 135 (e.g., UPF 135A, UPF 135B) of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QOS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIOT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; Qos handling for user plane, e.g. packet filtering, gating, UL/DL rate enforcement; Uplink Traffic verification (Service Data Flow (SDF) to Qos flow mapping); Downlink packet buffering and downlink data notification triggering.

As shown in FIG. 1, the NG-RAN 105 may support the PC5 interface between two UEs 125 (e.g., UE 125A and UE 125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may identify the sender of the data in NR sidelink communication. The Source Layer-2 ID may be 24 bits long and may be split in the medium access control (MAC) layer into two-bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two-bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

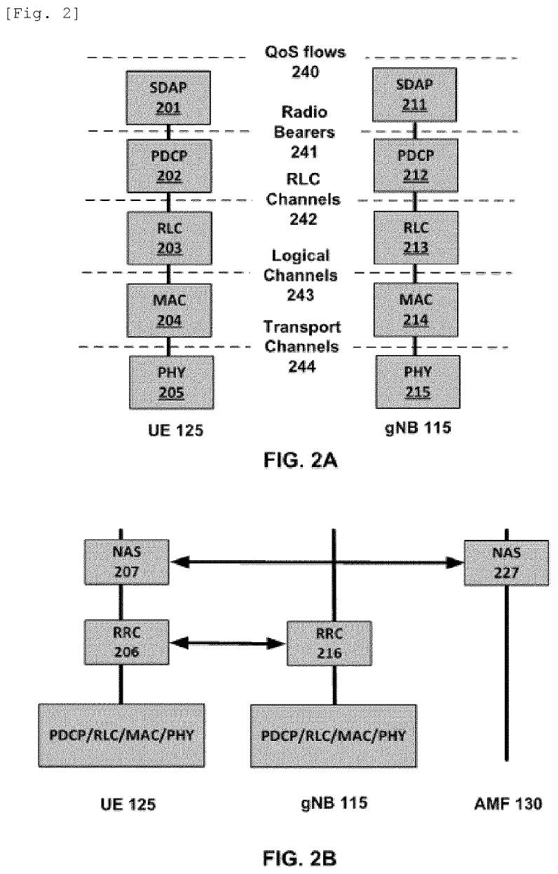

FIG. 2A and FIG. 2B show examples of radio protocol stacks for user plane and control plane, respectively, according to some aspects of one or more exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PDCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QOS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QOS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

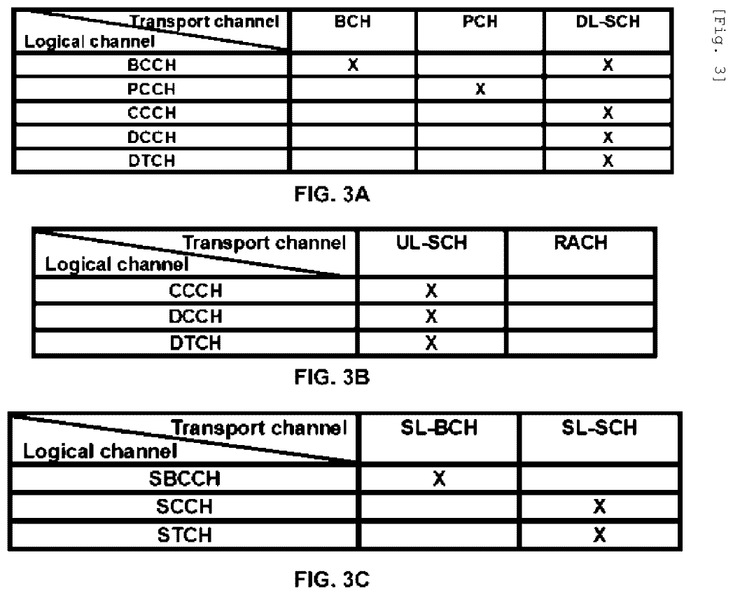

FIG. 3A, FIG. 3B and FIG. 3C show example mappings between logical channels and transport channels in downlink, uplink and sidelink, respectively, according to some aspects of one or more exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network.

This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

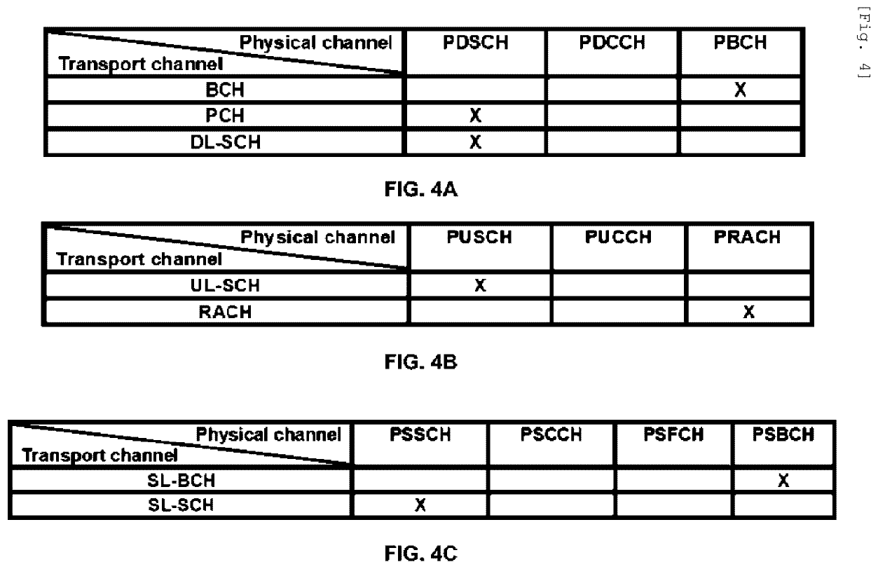

FIG. 4A, FIG. 4B and FIG. 4C show example mappings between transport channels and physical channels in downlink, uplink and sidelink, respectively, according to some aspects of one or more exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and Channel State Information (CSI) feedback triggers, etc. At least six Orthogonal Frequency Division Multiplexing (OFDM) symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may be mapped to the PSCCH.

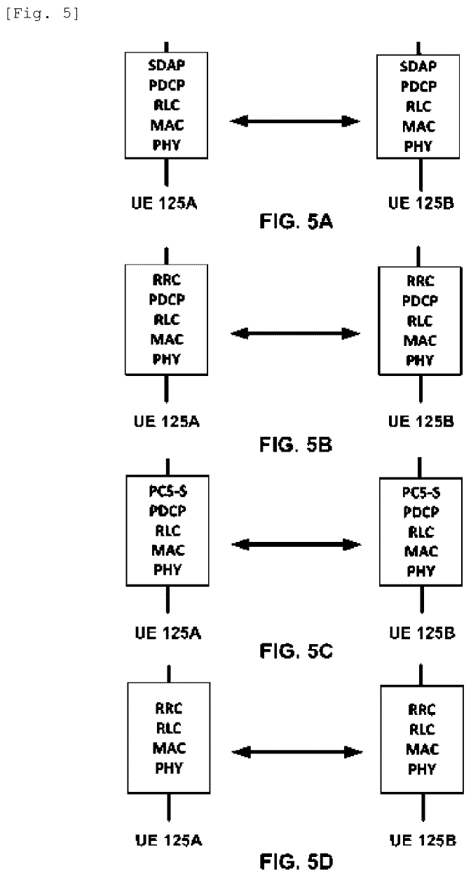

FIG. 5A, FIG. 5B, FIG. 5C and FIG. 5D show examples of radio protocol stacks for NR sidelink communication according to some aspects of one or more exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QOS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

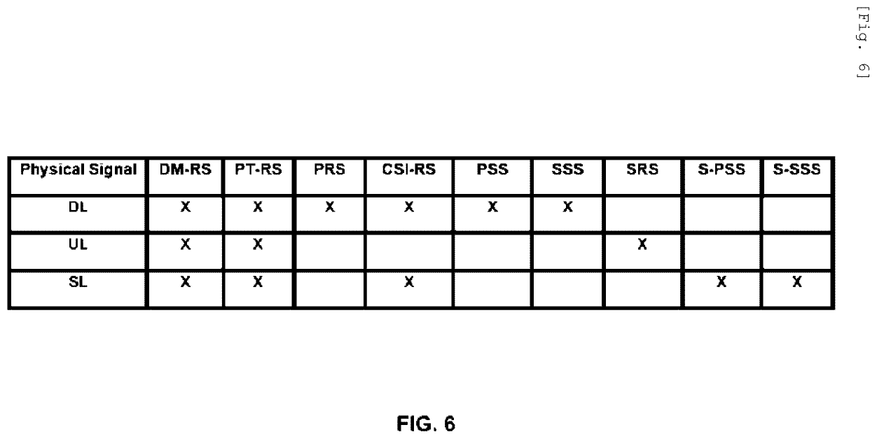

FIG. 6 shows example physical signals in downlink, uplink and sidelink according to some aspects of one or more exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC control element (CE). The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

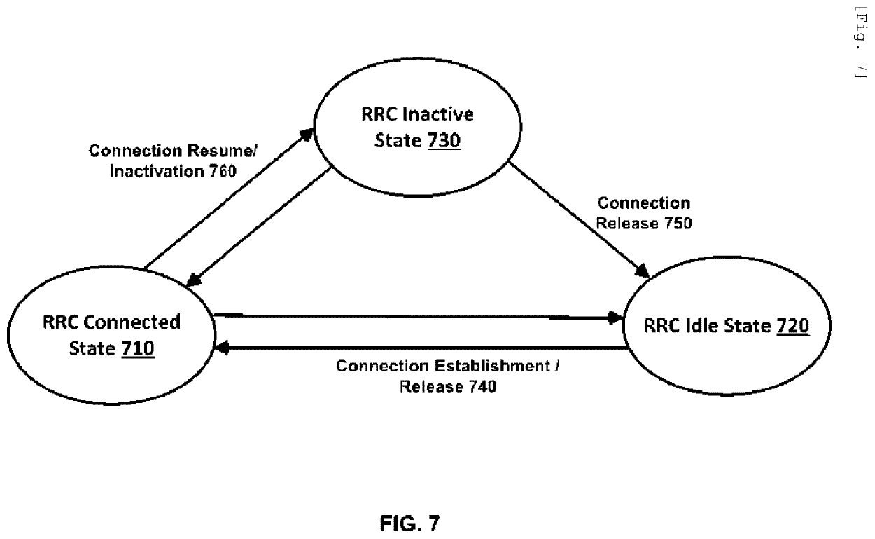

FIG. 7 shows examples of Radio Resource Control (RRC) states and transitioning between different RRC states according to some aspects of one or more exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

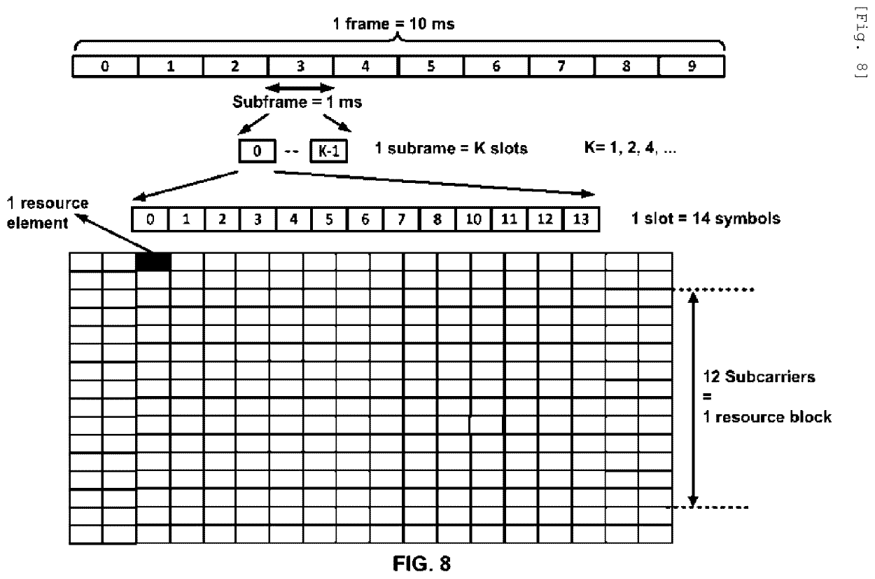

FIG. 8 shows example frame structure and physical resources according to some aspects of one or more exemplary embodiments of the present disclosure. The downlink or uplink or sidelink transmissions may be organized into frames with 10 (0 to 9) 1 ms subframes. Each subframe may consist of k slots (k=1, 2, 4, . . . ), wherein the number of slots k per subframe may depend on the subcarrier spacing of the carrier on which the transmission takes place. The slot duration may be 14 (0 to 13) symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during two, four or seven OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

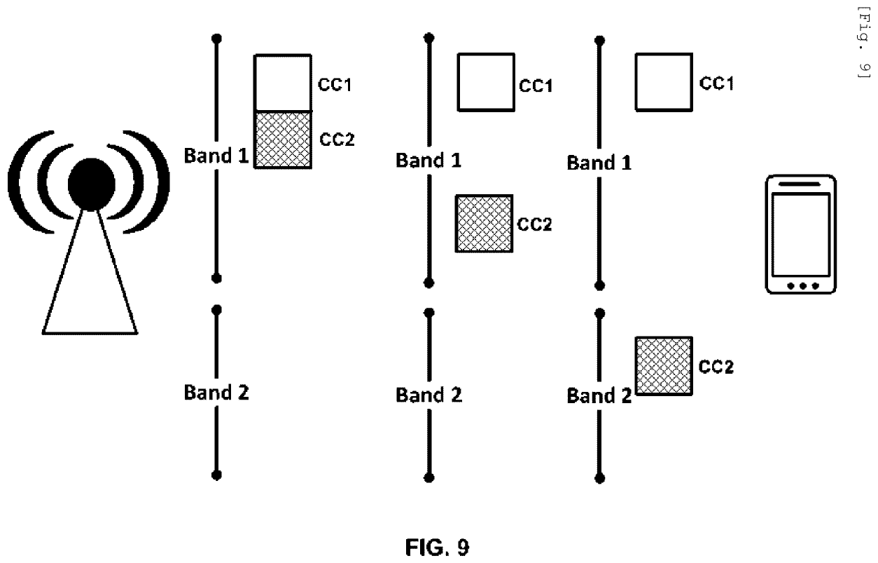

FIG. 9 shows example component carrier configurations in different carrier aggregation scenarios according to some aspects of one or more exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary Cell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity for the MCG for communications with the master base station and one MAC entity for the SCG for communications with the secondary base station.

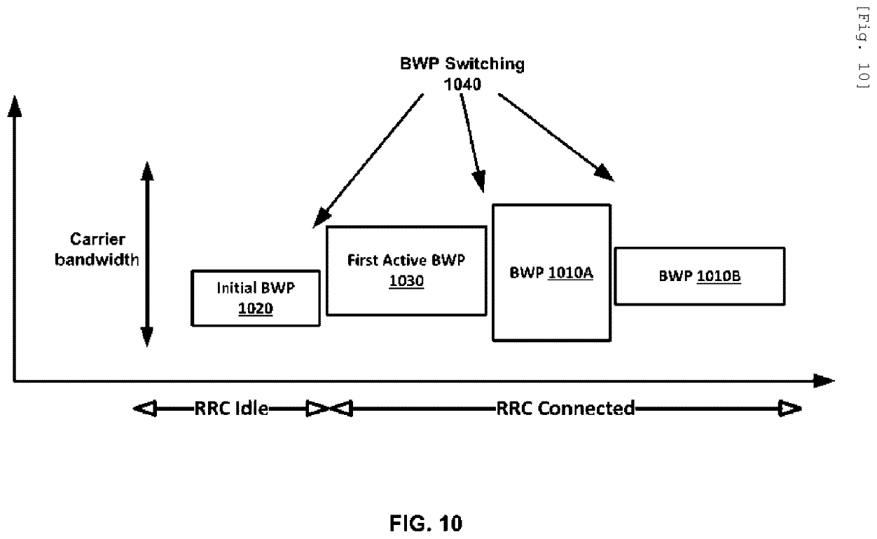

FIG. 10 shows example bandwidth part configuration and switching according to some aspects of one or more exemplary embodiments of the present disclosure. The UE may be configured with one or more Bandwidth Parts (BWPs) 1010 (e.g., 1010A, 1010B) on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1030 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

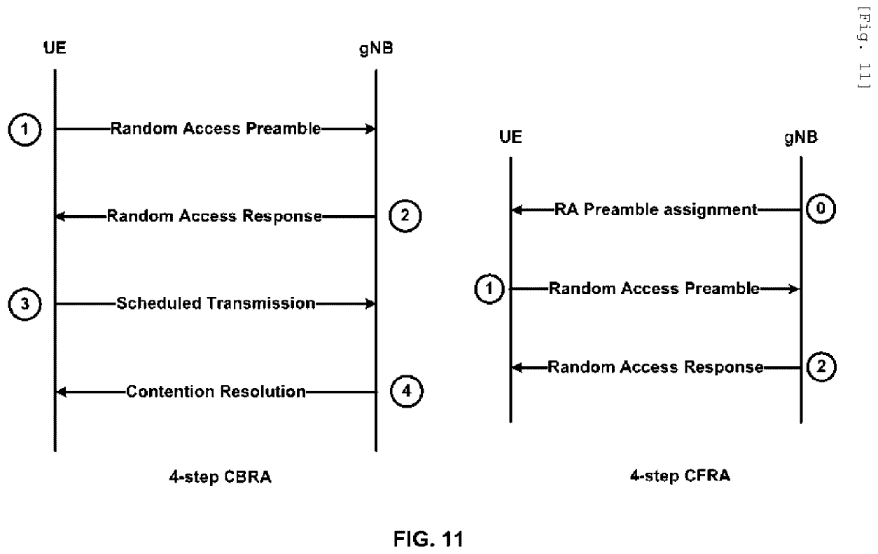

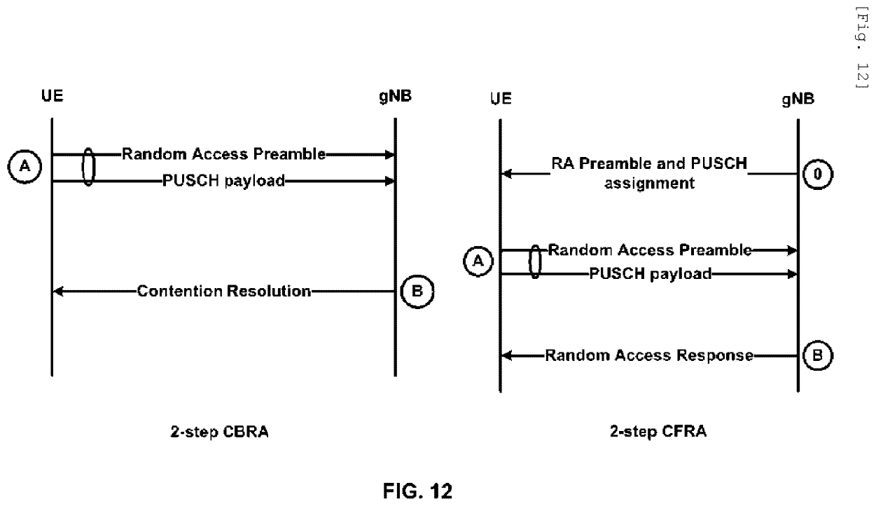

FIG. 11 shows example four-step contention-based random access (CBRA) and contention-free random access (CFRA) processes according to some aspects of one or more exemplary embodiments of the present disclosure. FIG. 12 shows example two-step contention-based random access (CBRA) and contention-free random access (CFRA) processes according to some aspects of one or more exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH (Step 1 of CBRA in FIG. 11). After MSG1 transmission, the UE may monitor for a response from the network within a configured window (Step 2 of CBRA in FIG. 11). For CFRA, dedicated preamble for MSG1 transmission may be assigned by the network (Step 0 of CFRA of FIG. 11) and upon receiving Random Access Response (RAR) from the network, the UE may end the random access procedure as shown in FIG. 11 (Steps 1 and 2 of CFRA in FIG. 11). For CBRA, upon reception of the random access response (Step 2 of CBRA in FIG. 11), the UE may send MSG3 using the uplink grant scheduled in the random access response (Step 3 of CBRA in FIG. 11) and may monitor contention resolution as shown in FIG. 11 (Step 4 of CBRA in FIG. 11). If contention resolution is not successful after MSG3 (re)transmission(s), the UE may go back to MSG1 transmission.

The MSGA of the 2-step RA type may include a preamble on PRACH and a payload on PUSCH (e.g., Step A of CBRA in FIG. 12). After MSGA transmission, the UE may monitor for a response from the network within a configured window. For CFRA, dedicated preamble and PUSCH resource may be configured for MSGA transmission (Steps 0 and A of CFRA in FIG. 12) and upon receiving the network response (Step B of CFRA in FIG. 12), the UE may end the random access procedure as shown in FIG. 12. For CBRA, if contention resolution is successful upon receiving the network response (Step B of CBRA in FIG. 12), the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

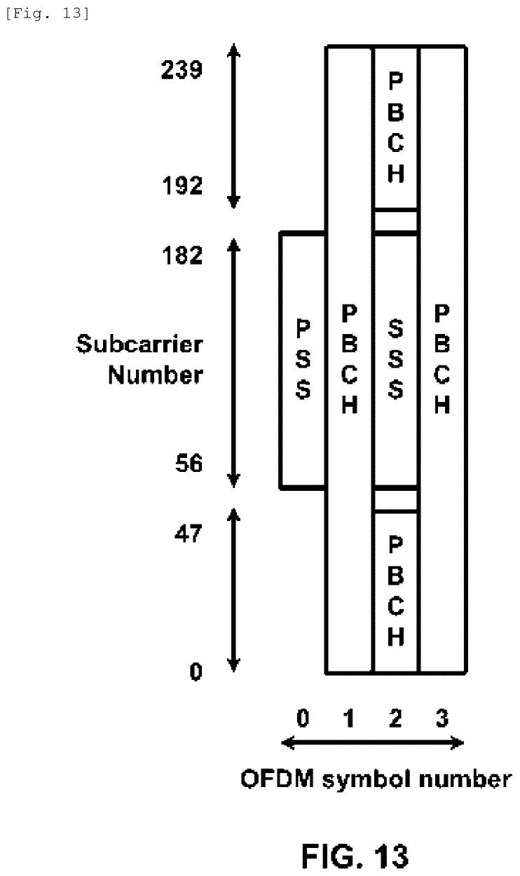

FIG. 13 shows example time and frequency structure of Synchronization Signal and Physical Broadcast Channel (PBCH) Block (SSB) according to some aspects of one or more exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e. using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

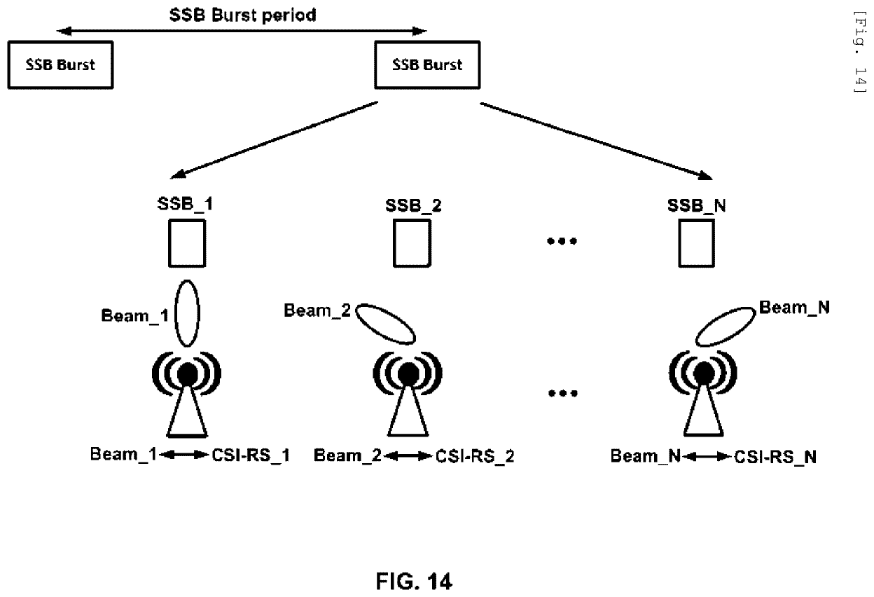

FIG. 14 shows example SSB burst transmissions according to some aspects of one or more exemplary embodiments of the present disclosure. An SSB burst may include N SSBs (e.g., SSB_1, SSB_2, . . . , SSB_N) and each SSB of the N SSBs may correspond to a beam (e.g., Beam_1, Beam_2, . . . , Beam_N). The SSB bursts may be transmitted according to a periodicity (e.g., SSB burst period). During a contention-based random access process, a UE may perform a random access resource selection process, wherein the UE first selects an SSB before selecting an RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource (e.g., CSI-RS_1, CSI-RS_2, . . . , CSI-RS_N). A UE may measure CSI-RS resources and may select a CSI-RS with RSRP above a configured threshold value. The UE may select a random access preamble corresponding to the selected CSI-RS and may transmit the selected random access preamble to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depend on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

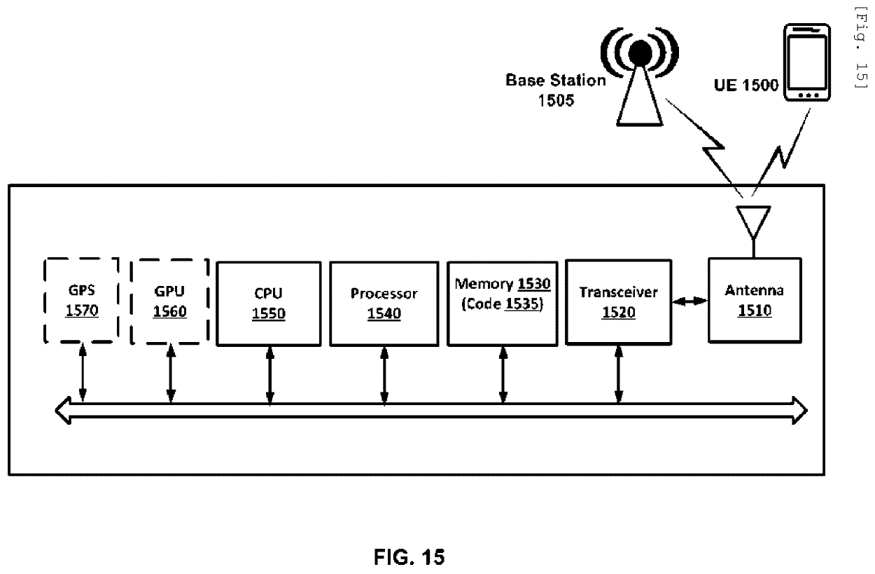

FIG. 15 shows example components of a user equipment and a base station for transmission and/or reception according to some aspects of one or more exemplary embodiments of the present disclosure. In one embodiment, the illustrative components of FIG. 15 may All or a subset of blocks and functions in FIG. 15 may be considered to be illustrative of a functional blocks of an illustrative base station 1505. In another embodiment, the illustrative components of FIG. 15 may be considered to be illustrative of a functional blocks of an illustrative user equipment 1500. Accordingly, the components illustrated in FIG. 15 are not necessarily limited to either a user equipment or base station.

With reference to FIG. 15, the Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some embodiments, depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The CPU 1550 may perform basic arithmetic, logic, controlling, and Input/output (I/O) operations specified by the computer instructions in the Memory 1530. The UE 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the UE 1500 and/or the base station 1505. The GPS 1570 may be used for enabling location-based services or other services for example based on geographical position of the UE 1500.

In some example, MBS services may be enabled via single-cell transmission. MBS may be transmitted in the coverage of a single cell. One or more Multicast/Broadcast control channels (e.g., MCCHs) and one or more Multicast/Broadcast data channels (e.g., MTCHs) may be mapped on DL-SCH. The scheduling may be done by the gNB. The Multicast/Broadcast control channel and the Multicast/Broadcast data channel transmissions may be indicated by a logical channel specific RNTI on PDCCH. In some examples, a one-to-one mapping between a service identifier such as a temporary mobile group identifier (TMGI) and a RAN level identifier such as a group identifier (G-RNTI) may be used for the reception of the DL-SCH to which a Multicast/Broadcast data channel may be mapped. In some examples, a single transmission may be used for DL-SCH associated with the Multicast/Broadcast control channel and/or the Multicast/Broadcast data channel transmissions and HARQ or RLC retransmissions may not be used and/or an RLC Unacknowledged Mode (RLC UM) may be used. In other examples some feedback (e.g., HARQ feedback or RLC feedback) may be used for transmissions via Multicast/Broadcast control channel and/or Multicast/Broadcast data channels.

In some example, for Multicast/Broadcast data channel, the following scheduling information may be provided on Multicast/Broadcast control channel: a Multicast/Broadcast data channel scheduling cycle, a Multicast/Broadcast data channel on-duration (e.g., duration that the UE waits for, after waking up from DRX, to receive PDCCHs), a Multicast/Broadcast data channel inactivity timer (e.g., duration that the UE waits to successfully decode a PDCCH, from the last successful decoding of a PDCCH indicating the DL-SCH to which this Multicast/Broadcast data channel is mapped, failing which it re-enters DRX).

In some examples, one or more UE identities may be related to MBS transmissions. The one or more identities may comprise at least one of: one or more first RNTIs that identify transmissions of the Multicast/Broadcast control channel; one or more second RNTIs that identify transmissions of a Multicast/Broadcast data channels. The one or more first RNTIs that identify transmissions of the Multicast/Broadcast control channel may comprise a single cell RNTI (SC-RNTI, other names may be used). The one or more second RNTIs that identify transmissions of a Multicast/Broadcast data channels may comprise a G-RNTI (nG-RNTI or other names may be used).

In some examples, one or more logical channels may be related to MBS transmissions. The one or more logical channels may comprise a Multicast/Broadcast control channel. The Multicast/Broadcast control channel may be a point-to-multipoint downlink channel used for transmitting MBS control information from the network to the UE, for one or several Multicast/Broadcast data channel. This channel may be used by UEs that receive or are interested to receive MBS. The one or more logical channels may comprise a Multicast/Broadcast data channel. This channel may be a point-to-multipoint downlink channel for transmitting MBS traffic data from the network.

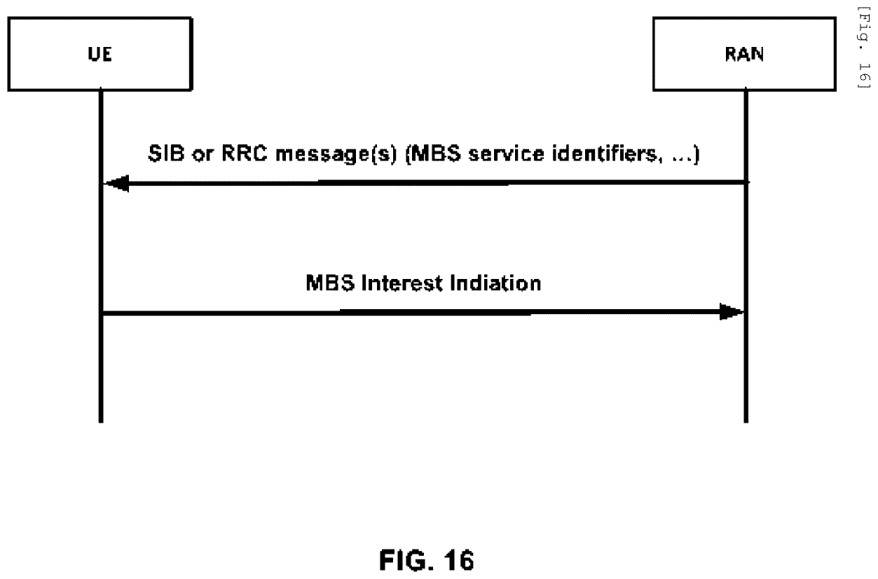

In some examples, a procedure may be used by the UE to inform RAN that the UE is receiving or is interested to receive MBS service(s) via an MBS radio bearer, and if so, to inform the 5G RAN about the priority of MBS versus unicast reception or MBS service(s) reception in receive only mode. An example is shown in FIG. 16. The UE may transmit a message (e.g., an MBS interest indication message) to inform RAN that the UE is receiving/interested to receive or no longer receiving/interested to receive MBS service(s). The UE may transmit the message based on receiving one or more messages (e.g., a SIB message or a unicast RRC message) from the network for example indicating one or more MBS Service Area Identifiers of the current and/or neighboring carrier frequencies.

In some examples, the UE may consider an MBS service to be part of the MBS services of interest if the UE is capable of receiving MBS services (e.g., via a single cell point to multipoint mechanism); and/or the UE is receiving or interested to receive this service via a bearer associated with MBS services; and/or one session of this service is ongoing or about to start; and/or at least one of the one or more MBS service identifiers indicated by network is of interest to the UE.

In some examples, control information for reception of MBS services may be provided on a specific logical channel: (e.g., a MCCH). The MCCH may carry one or more configuration messages which indicate the MBS sessions that are ongoing as well as the (corresponding) information on when each session may be scheduled, e.g., scheduling period, scheduling window and start offset. The one or more configuration messages may provide information about the neighbor cells transmitting the MBS sessions which may be ongoing on the current cell. In some examples, the UE may receive a single MBS service at a time, or more than one MBS services in parallel.

In some example, the MCCH information (e.g., the information transmitted in messages sent over the MCCH) may be transmitted periodically, using a configurable repetition period. The MCCH transmissions (and the associated radio resources and MCS) may be indicated on PDCCH.

In some examples, change of MCCH information may occur at specific radio frames/subframes/slots and/or a modification period may be used. For example, within a modification period, the same MCCH information may be transmitted a number of times, as defined by its scheduling (which is based on a repetition period). The modification period boundaries may be defined by SFN values for which SFN mod m=0, where m is the number of radio frames comprising the modification period. The modification period may be configured by a SIB or by RRC signaling.

In some examples, when the network changes (some of) the MCCH information, it may notify the UEs about the change in the first subframe/slot which may be used for MCCH transmission in a repetition period. Upon receiving a change notification, a UE interested to receive MBS services may acquire the new MCCH information starting from the same subframe/slot. The UE may apply the previously acquired MCCH information until the UE acquires the new MCCH information.

In an example, a system information block (SIB) may contain the information required to acquire the control information associated transmission of MBS. The information may comprise at least one of: one or more discontinuous reception (DRX) parameters for monitoring for scheduling information of the control information associated transmission of MBS, scheduling periodicity and offset for scheduling information of the control information associated transmission of MBS, modification period for modification of content of the control information associated transmission of MBS, repetition information for repetition of the control information associated transmission of MBS, etc.

In an example, an information element (IE) may provide configuration parameters indicating, for example, the list of ongoing MBS sessions transmitted via one or more bearers for each MBS session, one or more associated RNTIs (e.g., G-RNTI, other names may be used) and scheduling information. The configuration parameters may comprise at least one of: one or more timer values for discontinuous reception (DRX) (e.g., an inactivity timer or an On Duration timer), an RNTI for scrambling the scheduling and transmission of a Multicast/Broadcast traffic channel (e.g., MTCH, other names may be used), ongoing MBS session, one or more power control parameters, one or more scheduling periodicity and/or offset values for one or more MBS traffic channels, information about list of neighbor cells, etc.

Example embodiments may enable RAN functions for broadcast/multicast for UEs in RRC_CONNECTED state, RRC_IDLE state and RRC_INACTIVE state. A group scheduling mechanism may be used to allow UEs to receive Broadcast/Multicast service. In some example, Broadcast/Multicast service may be enabled to simultaneously operate with unicast reception. In some example, Broadcast/Multicast service delivery may be dynamically changed between multicast (PTM) and unicast (PTP) with service continuity for a given UE. In some examples, a coordination function may reside in the gNB-CU. In some examples, reliability of Broadcast/Multicast service may be improved by UL feedback. The level of reliability may be based on the requirements of the application/service provided. In some examples, the Broadcast/Multicast transmission area may be dynamically controlled within one gNB-DU.

In some examples, a MAC entity may be configured by RRC with a DRX functionality that controls the UE's PDCCH monitoring activity for a number of the MAC entity's RNTIs. The RNTIs may comprise C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, and AI-RNTI. When in RRC CONNECTED, if DRX is configured, for the activated Serving Cells, the MAC entity may monitor the PDCCH discontinuously using the DRX operation; otherwise the MAC entity may monitor the PDCCH.

RRC may control DRX operation by configuring the a plurality of parameters including drx-onDurationTimer: the duration at the beginning of a DRX Cycle; drx-SlotOffset: the delay before starting the drx-onDurationTimer; drx-InactivityTimer: the duration after the PDCCH occasion in which a PDCCH indicates a new UL or DL transmission for the MAC entity; drx-RetransmissionTimerDL (per DL HARQ process except for the broadcast process): the maximum duration until a DL retransmission is received; drx-RetransmissionTimerUL (per UL HARQ process): the maximum duration until a grant for UL retransmission is received; drx-LongCycleStartOffset: the Long DRX cycle and drx-StartOffset which defines the subframe where the Long and Short DRX Cycle starts; drx-ShortCycle (optional): the Short DRX cycle; drx-ShortCycleTimer (optional): the duration the UE may follow the Short DRX cycle; drx-HARQ-RTT-TimerDL (per DL HARQ process except for the broadcast process): the minimum duration before a DL assignment for HARQ retransmission is expected by the MAC entity; drx-HARQ-RTT-TimerUL (per UL HARQ process): the minimum duration before a UL HARQ retransmission grant is expected by the MAC entity.

In some examples, an information element (e.g., an SPS-Config IE) may be used to configure downlink semi-persistent transmission. Multiple Downlink SPS configurations may be configured in one BWP of a serving cell. The SPS configuration parameters may comprise a periodicity parameter indicating periodicity of DL SPS resources, a sps-ConfigIndex indicating an index of one of multiple SPS configurations.

A UE may monitor a set of PDCCH candidates in the configured monitoring occasions in one or more configured Control REsource SETs (CORESETs) according to the corresponding search space configurations. A CORESET may comprised a set of physical resource blocks (PRBs) with a time duration of 1 to 3 OFDM symbols. The resource units Resource Element Groups (REGs) and Control Channel Elements (CCEs) may be defined within a CORESET with each CCE comprising a set of REGs. Control channels may be formed by aggregation of CCE. Different code rates for the control channels may be realized by aggregating different number of CCE. Interleaved and non-interleaved CCE-to-REG mapping may be supported in a CORESET.

In some examples, Semi-Persistent Scheduling (SPS) may be configured by RRC per Serving Cell and per BWP. Multiple assignments may be active simultaneously in the same BWP. Activation and deactivation of the DL SPS may be independent among the Serving Cells. For the DL SPS, a DL assignment may be provided by PDCCH, and stored or cleared based on L1 signaling indicating SPS activation or deactivation.

RRC may be configured the following parameters when the SPS is configured: CS-RNTI: CS-RNTI for activation, deactivation, and retransmission; nrofHARQ-Processes: the number of configured HARQ processes for SPS; harq-ProcID-Offset: Offset of HARQ process for SPS; periodicity: periodicity of configured downlink assignment for SPS.

In some examples, with Semi-Persistent Scheduling (SPS), the gNB may allocate downlink resources for the initial HARQ transmissions to UEs: RRC may define the periodicity of the configured downlink assignments and PDCCH addressed to CS-RNTI may signal and activate the configured downlink assignment, or deactivate it. A PDCCH addressed to CS-RNTI may indicate that the downlink assignment may be implicitly reused according to the periodicity defined by RRC, until deactivated.

In some examples, the MBS transmission may be restricted to one or more BWPs of a cell, for example an initial BWP of a cell. Some pre-configured/configurable MBS service may be broadcast via non-initial BWP. In some examples, an MBS service may be broadcast via one or more beams and not all beams associated with a cell. In some example, the same MBS message may be repeated in all transmitted beams in multi-beam operation.

In some examples, on-demand based System Information transmission may be provided. The on-demand based System Information transmission may improve efficiency, especially when considering low activity on the control channels, e.g. at night-time.

In some example, a UE in RRC_IDLE/RRC_INACTIVE state may receive a multicast session without entering RRC connected state.

In some examples, a UE may identify the active MBS services on a cell based on the list of supported services signaled as part of multicast control information in the transmission area. A UE that is interested in a service may execute a procedure to start PTM reception for the interested service. A UE in RRC IDLE or RRC INACTIVE state may be mobile and may perform cell reselection to a neighbor cell. For UEs interested to receive MBS services, and for cell reselection, the knowledge of MBS services support on the neighbor cells may be available for the UE. The availability and support of interested MBS service on neighbor cells may be available to a UE receiving PTM services in RRC_IDLE or RRC_INACTIVE state. If the availability of interested MBS services on neighbor cell is known, the UE may prioritize those cells or frequencies for cell reselection.

In some examples, upon cell reselection, the UE may acquire multicast control information on the target cell before it starts listening to multicast data transmission.

In some examples, a system information block (SIB) may be used to signal configuration required to receive a periodically transmitted multicast/broadcast control information. A multicast/broadcast control message may be introduced to signal the configuration required to receive multicast/broadcast session over a multicast traffic channel.

In some cases, not all the supported MBS services in a transmission area, may be available to UEs in all RRC states and some of the MBS transmissions in a cell may be reserved for reception in a specific RRC state, e.g., in RRC CONNECTED state. Based on the nature of MBS service, it may be observed that some of these services may be efficiently received in idle or inactive state e.g. IPTV, whereas some may be more efficiently served in RRC connected state e.g. mission critical services. For services that may be received in IDLE or INACTIVE states, the control information required to receive a multicast session may be available at UE before PTM reception. However, for services which are provisioned by gNB to be received only in RRC CONNECTED state, some control information may be signaled in connected state. In some example, some MBS services may only be supported in RRC CONNECTED state. For services that are available for UEs in RRC CONNECTED state, some multicast/broadcast control information may be provided using unicast signaling.

In some examples, resource may be flexibly allocated between Unicast and Broadcast/Multicast services. The network may deploy MBS services in subset of the carrier bandwidth and not across the entire carrier bandwidth. For example, a subset of BWPs in a cell may support MBS services while others may support unicast services. Since a BWP is associated with a subcarrier spacing (SCS)/numerology and different services may require different SCS. The services across the different MBS supported BWPs within a cell may be different. MBS services like public safety, mission critical, etc. may have different scheduling requirement than other use cases e.g. different SCS. In such cases, network may prefer to have these services in separate BWPs. In some examples, MBS services may be supported either per carrier or per bandwidth part. Different BWPs in a cell may provide different MBS services.

In some examples, PTM transmission may be based on DL-SCH, e.g., receiving MBS PTM bearer through monitoring a PDCCH scheduled group RNTI on PDSCH. The UEs may be provided with associated MBS MRB/DRB configuration(s) via dedicated RRC signaling.

In some examples, the multicast/broadcast service may be provided by DRB or MRB (C-RNTI/G-RNTI) and the actual dynamic switch and choice may be transparent to the UE. The decision for dynamic switching between multicast (PTM) and unicast (PTP/DRB) may be transparent to the UE. In some examples, providing physical layer enhancements like HARQ/feedback and including PDCP functionality for reordering and duplication detection (e.g., duplicate discard), additional reliability if needed (e.g. RLC AM) may be provided using a unicast bearer. The use of HARQ re-transmissions and HARQ feedback may be beneficial also for PTM.

In existing Point to Multipoint solutions, a single control channel is configured through a SIB2 and one or more traffic channels are configured by that control channel. The SIB, control channel and all traffic channels may be on the same carrier. While traffic channels may have different scheduling cycles, on duration and inactivity timers without any retransmissions but one control is configured and used for scheduling all traffic channels. Existing Point to Multipoint solutions lack flexibility and may lead to duplicate transmission of control information and inefficiency for delivering multicast broadcast services. Example embodiments enhance the multicast broadcast signaling and configuration.

Example embodiment may enable initial RAN level configuration of Multicast and Broadcast Service (MBS) related control information. The MBS mechanisms may be used to provide Multicast and Broadcast services and may also be used for Mission Critical Push-to-Talk (MCPTT), Internet of Things (IoT), and Vehicle-to-everything (V2X). In some embodiments, a cell may use the Physical Downlink Shared Channel (PDSCH) to send Multicast/Broadcast data and control information to a group of mobile communication devices. In some example, data of a Multicast/Broadcast service may be sent on the PDSCH using a group-specific Radio Network Temporary Identifier (e.g., G-RNTI, other names may be used), and control information may be sent on the PDSCH using an SC-PTM Radio Network Temporary Identifier (e.g., SC-RNTI, other names may be used).

In some example embodiments, to receive an MBS transmission, a mobile communication device may receive one or more of three items: System Information (e.g., provided by a System Information Block (SIB)), a Control channel for reception of Multicast/Broadcast control information (e.g., via a Multicast/Broadcast Control Channel (MCCH) logical channel, other names may be used) and Multicast/Broadcast data (e.g., via a Multicast/Broadcast Traffic Channel (MTCH) logical channel, other names may be used).

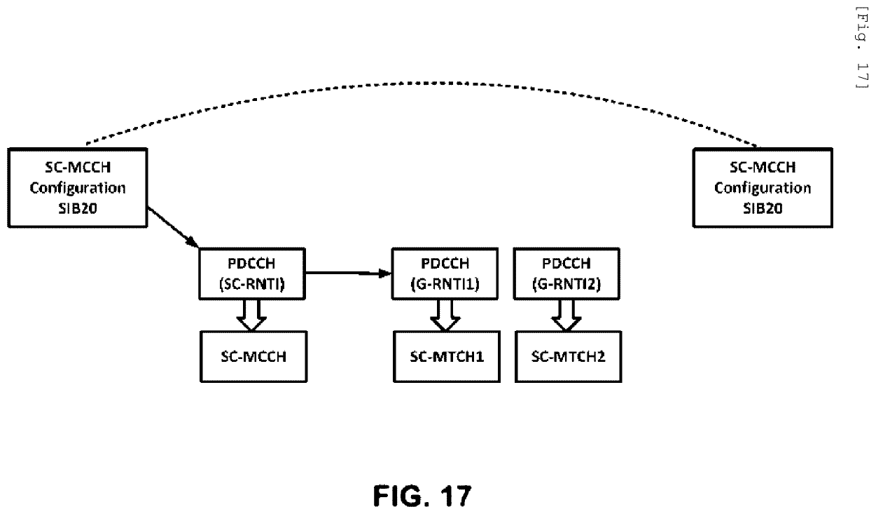

In some example embodiments as shown in FIG. 17, the system information provided by the SIB may indicate how to receive the Multicast/Broadcast control information (e.g., via the MCCH channel). The system information may indicate a modification period, for example wherein the control information may change, a repetition period/offset wherein the Multicast/Broadcast control information may be repeated, etc. In some examples, the above SIB information may be transmitted via unicast RRC signaling. The control information (e.g., the MCCH) may indicate available Multicast/Broadcast services via associated service identifiers (e.g., Temporary Mobile Group Identities (TMGIs), other names may be used) and how to receive the Multicast/Broadcast data (e.g., via the MTCH). The logical channel for transmission of the Multicast/Broadcast data (e.g., the MTCH) may be used to transfer data of one Multicast/Broadcast service. In some examples, the control information (e.g., the MCCH) may comprise a configuration message for configuration of MBS relate parameters. The configuration message may indicate ongoing Multicast/Broadcast sessions. The configuration message may further indicate information on which each session may be scheduled and may also include a neighbor cell list for potential neighbors providing a same service (e.g., the same service identifier such as the same TMGI).

In some example embodiments, the UEs in a 5G network may initially discover and subscribe to MBS services through application layer signaling or by other means e.g. pre-provisioning in the device. Such service discovery signaling/provisioning may provide UE with some service identifiers for the subscribed MBS services. These identifiers may comprise one or more Temporary Mobile Group Identity TMGIs. Other names for such identifiers may be used such as nTMGIs, etc.

In some example embodiments, one or more MBS content channels with similar radio transmission and/or Qos configuration requirements may be bundled together and may be assigned the same MBS service identifier, e.g. the same nTMGI. In some example, a UE that receives multiple MBS services may be provided with multiple nTMGIs one for each bundle service.

In some examples, service flows may be mapped to MBS radio bearers (MBRs) using 1:1 or N:1 mapping to service identifiers.

In some examples, a UE which has discovered the service identifier for its target MBS service may request RAN to provide the UE with the RAN level configuration for that MBS service. In some examples, the MBS server in the network may trigger RAN to send the MBS RAN level configuration to UE following UE's application layer registration with the server.

In some examples, a UE may transition to RRC Connected state (e.g., from an RRC Inactive state or an RRC Idle state) to exchange RRC signaling with the RAN to obtain initial MCCH configuration. The UE or MBS server may provide RAN with the list of target nTMGIs for UE. This MCCH configuration message signaling may be carried on UE's default BWP/Carrier and may also be carried on an LTE carrier.

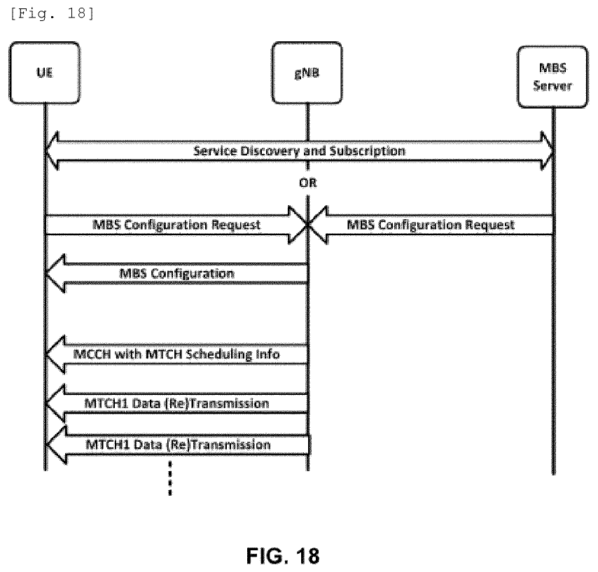

In some example embodiments as shown in FIG. 18, the configuration of Multicast/Broadcast control channel (e.g., MCCH) associated with UE's target MBS services (e.g. identified by nTMGIs) may be provided to UE as initiated by UE request or by MBS server in the network on UEs default active BWP on NR or on LTE carrier.

In some examples, the UEs may obtain one or more service level identifiers, e.g. nTMGIs, for their target MBS services as part of service discovery through application layer signaling or by other means such as device pre-provisioning.

In some examples, the network may use MBS capability for different use cases, including multimedia broadcasting and multicasting of contents such as videos, public safely group communications and also some Internet of Things (IoT) applications. In some examples, multiple concurrent MBS services with different traffic patterns, bandwidths and latency requirements may be configured. The network may offer MBS data with using a mix of different MCCH/MTCH configurations in terms of PHY numerologies, Bandwidth Parts (BWPs), periodicities and QOS requirements including but not limited to range and reliability.

In some examples, the UEs receiving an MBS service may be in RRC connected, idle or inactive state and may have different active or default Bandwidth parts on NR or LTE carriers. In some examples, UEs receiving MBS data may be on different active or default BWPs for their respective unicast services. Example embodiments may enable MBS configuration signaling to avoid directing UE's to track and process MBS information that are not relevant to their target services.

In some examples, to support diverse MBS use cases, a UE may be configured and/or may be scheduled with a mix of different and possibly concurrent Multicast/Broadcast control and traffic channels (e.g., MCCH/MTCHs) with different PHY numerologies, Bandwidth Parts (BWPs), periodicities and QOS requirements and/or reliabilities.

In some examples, UEs within the group receiving MBS service may be in different RRC states and/or on different NR carriers/BWPs or on an LTE carrier for their other, e.g. unicast, services.

In some examples, MBS RAN Configuration signaling may allow delivery of MBS control information for one of multiple MBS services delivered on multiple numerologies, BWPs, periodicity and with different reliability requirements.

In some examples, MBS RAN Configuration signaling may allow efficient delivery of relevant MBS control information for to target UEs which may be on different NR Carrier/BWPs or LTE carriers and in different RRC states.

In some examples, MBS configuration signaling may consider UE's power saving by ensuring that UEs only track and process the information relevant to their target services.

In some example, the MBS RAN level configuration information may comprise of two parts: the configuration of control channel (e.g., MCCH) transmissions and configuration of scheduling of associated data channel (e.g., MTCH) transmissions.

In some example, a SIB indicating information for receiving the Multicast/Broadcast control channel (e.g., MCCH) may be requested by the UE on demand. The UE may start a random access process and may indicate a request for on-demand delivery of the SIB that includes information for receiving the Multicast/Broadcast control channel.

In some example, the Multicast/Broadcast control channel (e.g., MCCH) configuration may be indicated to the UE using unicast RRC signaling.

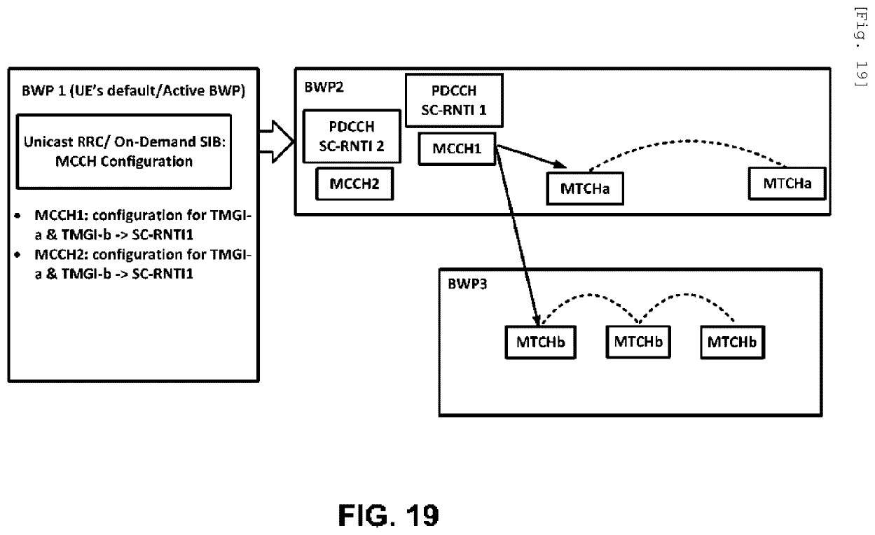

In some example embodiments as shown in FIG. 19, configuration parameters of the Multicast/Broadcast control channel (e.g., MCCH) may indicate a BWP (e.g., may include one or more BWP IDs) and/or a cell/carrier (e.g., may include one or more cell IDs) and/or a CORESET (e.g., may include one or more CORESET IDs) wherein the Multicast/Broadcast control channel is scheduled (e.g., via a DCI scheduling the Multicast/Broadcast control channel) and/or transmitted. The configuration parameters of the Multicast/Broadcast control channel (e.g., MCCH) may further indicate a Modification Period, Repetition Period and Offset. In some example embodiments, the UE may be configured with one or more RNTIs for reception of the Multicast/Broadcast control channel (e.g., MCCH). In an example, an RNTI of the one or more RNTIs may be used to identify the DCI in the configured CORESET/BWP to point to PDSCH carrying Multicast/Broadcast control channel message.

In some example embodiments, the base station may configure periodic resources (e.g., Semi-Persistent Scheduling (SPS) or Configured Scheduling (CS) resources) for downlink transmission of Multicast/Broadcast control channel (e.g., MCCH). The periodic resource for transmission of Multicast/Broadcast control channel may be preconfigured by RRC and may be activated or deactivated with DCI signaling. In some examples, the configuration parameters may indicate that the periodic resource are configured on a different BWP/Carrier than the BWP/carrier that the Multicast/Broadcast control channel is received.

In some examples, the RAN may be offering different MBS services with different radio and QoS configuration requirements across overlapping or disjoint group of member UEs. Using a single MCCH configuration for scheduling all Multicast/Broadcast data channels (e.g., MTCHs) carrying MBS services with different numerologies, BWPs, latency, periodicity and reliability requirements may be limiting and also negatively impact power saving for UE monitoring such MCCH transmissions. In some example embodiments, the MBS configuration signaling may allow configuration of multiple Multicast/Broadcast channels (e.g., MCCHs) on the same or different BWPs for scheduling MBSs with different transmission frequency, periodicity/timing and reliability requirements.

In some examples, a group identifier at RAN level (e.g., nG-RNTI) may be assigned to an MBS bundle service, e.g. associated with the nTMGI. This nG-RNTI may be used within RAN for DCI signaling related to Multicast/Broadcast data channels (e.g., MTCH) scheduling for associated with MBS services. This nG-RNTI may be used by UEs to track and find MTCHs associated with the target MBS service.

In some examples, Multicast/Broadcast control channel (e.g., MCCH) may include a RAN level identifier, e.g. nG-RNTI used in DCI signaling for UEs to keep track of Multicast/Broadcast data channels (e.g., MTCH) transmissions for that MBS bundle.

In some examples, the Multicast/Broadcast control channel (e.g., MCCH) may include scheduling information for one or multiple c. The UE may switch to BWP/Carrier where and when Multicast/Broadcast control channel is configured to be and decode the Multicast/Broadcast control channel to obtain information about transmission of MBS data on Multicast/Broadcast data channel or receive the Multicast/Broadcast data channel data and then switch to default BWP if needed.

In some examples, the Multicast/Broadcast control channel (e.g., MCCH) may be used to schedule one or more Multicast/Broadcast control channel (e.g., MCCH) on the same or different BWPs.

In some example, the UEs receiving MBS data on a different BWP may be configured to switch back to their default/active BWP after they receive the MBS information within a configurable time.

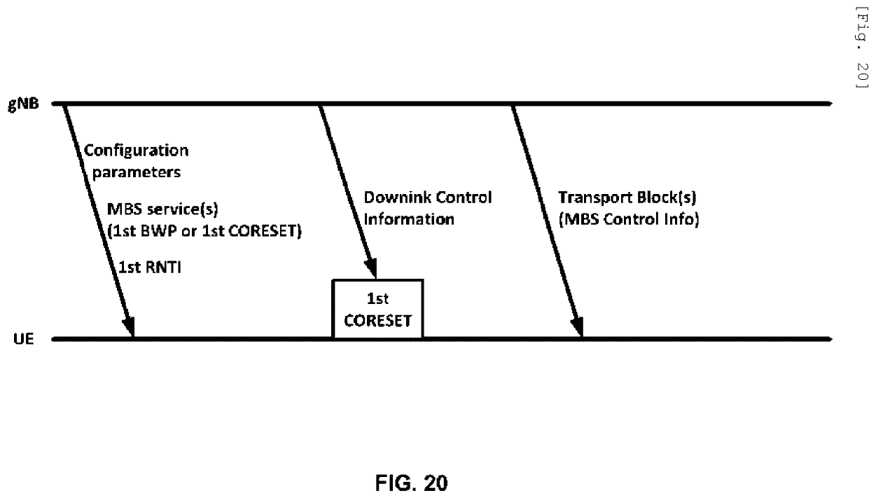

FIG. 20 shows an example process according to some aspects of one or more exemplary embodiments of the present disclosure. Illustratively, FIG. 20 illustrates the methodologies implemented a UE 125 and a gNB 115 for configuration or implementation of multicast broadcast messages. In an example embodiment as shown in FIG. 20, the UE may receive one or more messages comprising configuration parameters from a RAN node, illustratively gNB 115 or ng_eNB 120. In some examples, the one or more messages may comprise one or more RRC messages. In some examples, the one or more messages may comprise system information transmitted via one or more system information blocks (SIBs). In some examples, the gNB may transmit, and the UE may receive, the one or more messages based on starting a random access process for reception of on-demand system information. The UE may start a random access process by transmitting a random access preamble for on-demand reception of system information to the gNB. The gNB may transmit, and the UE may receive the one or more messages based on starting the random access process. In some examples, the UE may perform a service discovery process and may determine that the one or more multicast and broadcast services are of interest to the UE. In some examples, the gNB may transmit, and the UE may receive, the one or more messages via a default BWP (e.g., the default BWP of a primary cell).

In some examples, the UE may receive the one or more messages based on transitioning from an RRC Idle state to an RRC connected state or transitioning from an RRC Inactive state to the RRC connected state. The UE may transition from the RRC idle state to the RRC connected state or from the RRC inactive state to the RRC connected state based on the service discovery process indicating that the one or more multicast broadcast services are of interest to the UE.

In some examples, the configuration parameters may indicate that one or more multicast broadcast services are associated with one or more first CORESETs. In some examples, the configuration parameters may indicate that one or more multicast broadcast services are associated with one or more first BWPs. In some examples, the configuration parameters may indicate that one or more multicast broadcast services are associated with at least one of: one or more first CORESETs and the first bandwidth part (BWP). In some examples, the one or more messages may comprise configuration parameters of the one or more first CORESETs on the one or more first BWPs. The one or more multicast broadcast services may be associated with the one or more first CORESETs based on receiving scheduling information for the multicast broadcast control information associated with the one or more multicast broadcast services via the one or more first CORESETs. The one or more multicast broadcast services may be associated with the one or more first BWPs based on receiving scheduling information for the multicast broadcast control information associated with the one or more multicast broadcast services via the one or more first BWPs.

The one or more messages may further comprise one or more first RNTIs associated with the one or more multicast broadcast services. The cyclic redundancy check (CRC) bits of a downlink control information that indicates scheduling information for one or more downlink transport blocks may be scrambled with an RNTI in the one or more first RNTIs. The one or more transport blocks may comprise control information for the one or more multicast broadcast services.

The UE may receive one or more downlink control information associated with the one or more first RNTIs. In some example, the one or more multicast broadcast services may be associated with service identifiers (e.g., TMGIs, etc.) and the one or more RNTIs may be associated with the one or more service identifiers. The CRC bits of the one or more downlink control information may be scrambled with the one or more first RNTIs. The UE may receive the one or more downlink control information via the one or more first CORESETs and/or via the one or more first BWPs. In some examples, the UE may determine that the one or more downlink control information are associated with the one or more multicast broadcast services based on receiving the one or more downlink control information via the one or more first CORESETs and/or the one or more first BWPs. In some examples, the UE may determine that the one or more downlink control information are associated with the one or more multicast broadcast services based on the one or more downlink control information being associated with the one or more first RNTIs.

The UE may receive one or more transport blocks based on the scheduling information indicated by the one or more downlink control information. The scheduling information may indicate radio resources for reception of the one or more transport blocks. The one or more transport blocks may be associated with the one or more multicast broadcast services. The one or more transport blocks may comprise control information for receiving one or more traffic/data channels associated the one or more multicast broadcast services.

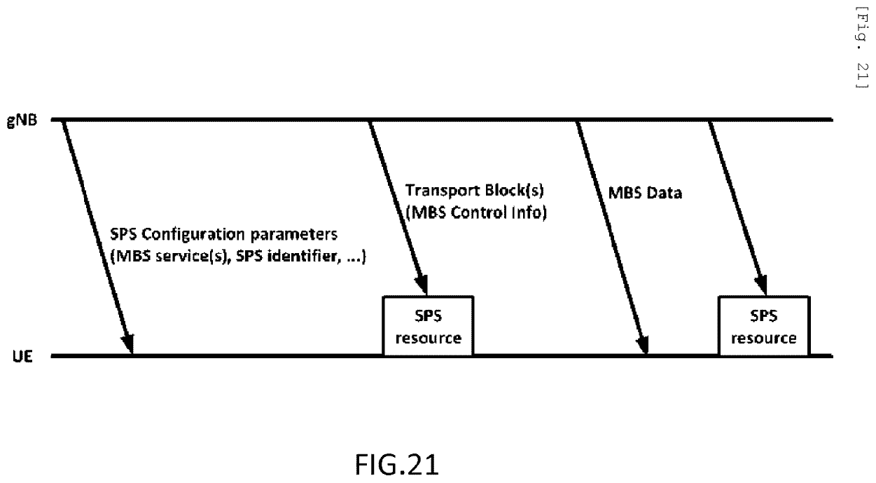

In an example embodiment as shown in FIG. 21, the UE may receive configuration parameters of a semi-persistent scheduling (SPS) configuration. The SPS configuration parameters may be used by the UE to determine SPS resources. The UE may determine the SPS resources based on the SPS configuration and based on an activation DCI indicating activation of the SPS configuration. The UE may receive an activation DCI indicating the activation of the SPS configuration. The SPS configuration may be associated with the one or more multicast broadcast services. The SPS configuration parameters may indicate that the SPS configuration is associated with the one or more multicast broadcast services. In some examples, the SPS configuration parameters may comprise a SPS configuration identifier indicating that the SPS configuration is associated with the one or more multicast broadcast services.

The wireless device may determine a SPS resource based on the SPS configuration parameters (e.g., in combination with an activation DCI). The wireless device may receive one or more transport blocks via the SPS resource. The one or more transport blocks may be associated with the one or more multicast broadcast services. The one or more transport blocks may comprise control information for receiving one or more traffic/data channels associated the one or more multicast broadcast services.

In some examples, the one or more transport blocks associated with the one or more multicast broadcast services and comprising control information for the one or more multicast broadcast services may comprise one or more of the following information: one or more service identifiers for the one or more multicast broadcast services (e.g., one or more TMGIs or identifiers or other identifiers associated with the one or more TMGIs); one or more second RNTIs for reception of downlink data associated with the one or more service identifiers, for example for reception of multicast broadcast traffic channels associated with the one or more multicast broadcast services; one or more BWP identifiers of one or more BWPs for reception of the one or more multicast broadcast services; one or more numerologies (e.g., subcarrier spacing or cyclic prefix associated with the one or more BWPs) for reception of the one or more multicast broadcast services; one or more quality of service requirements (e.g., latency, jitter, throughput, etc.) for the one or more multicast broadcast services; one or more periodicities (e.g., periodicities for reception of the one or more multicast broadcast control information or periodicities for reception of the one or more multicast broadcast traffic channels) associated with the one or more multicast broadcast services; one or more cell identifiers of one or more cells for reception of the one or more multicast broadcast services; one or more discontinuous reception (DRX) parameters for monitoring one or more radio network temporary identifiers (RNTIs) associated with the one or more multicast broadcast services (e.g., a first DRX parameter, such as a first inactivity timer value or a first ON duration value associated with a first multicast broadcast traffic channel and a second DRX parameter such as a second inactivity timer value or a second ON duration timer value associated with a second multicast broadcast traffic channel); and a neighbor cell information list indicating one or more neighbor cells for reception of the one or more multicast broadcast services for example the neighbor cells that the one or more multicast broadcast services are available; etc.

In some examples, the UE may switch to a first BWP (e.g., switch from a current active BWP to the first BWP) for reception of one or more multicast broadcast services. The first BWP may be the BWP wherein the multicast broadcast services are available (e.g., the multicast broadcast traffic channels are transmitted). In some examples, the UE may switch to a second BWP (e.g., the previously active BWP or a default BWP) after a time (e.g., a configurable time) from switching to the first BWP. The UE may start a timer based on switching to the first BWP and may switch to the second BWP based on the timer expiring. The configuration parameters may indicate the timer value.

In an embodiment, a UE may receive one or more messages comprising: configuration parameters indicating that one or more multicast broadcast services is associated with at least one of: a first control resource set (CORESET) and a first bandwidth part (BWP); and one or more first radio network temporary identifiers (RNTIs) associated with the one or more multicast broadcast services. The UE may receive, via the first CORESET or the first BWP, one or more downlink control information associated with the one or more first RNTIs. The UE may receive based on the one or more downlink control information, one or more transport blocks associated with the one or more multicast broadcast services. In some embodiments, the configuration parameters may comprise first configuration parameters of the first CORESET on the first BWP.

In an embodiment, a UE may receive configuration parameters of a semi-persistent scheduling (SPS) configuration associated with one or more multicast broadcast services. The UE may receive based on a SPS resource associated with the SPS configuration, one or more transport blocks associated with the one or more multicast broadcast services.

In some embodiment, the configuration parameters may comprise a first identifier indicating that the SPS configuration is associated with the one or more multicast broadcast services. In some embodiments, the UE may receive a downlink control information indicating activation of the SPS configuration.

In some embodiments, the one or more transport blocks may comprise control information associated with the one or more multicast broadcast services. In some embodiments, the control information indicates at least one of: one or more service identifiers for the one or more multicast broadcast services; one or more second RNTIs for reception of downlink data associated with the one or more service identifiers; one or more BWP identifiers of one or more BWPs for reception of the one or more multicast broadcast services; one or more numerologies for reception of the one or more multicast broadcast services; one or more quality of service requirements for the one or more multicast broadcast services; one or more periodicities associated with the one or more multicast broadcast services; one or more cell identifiers of one or more cells for reception of the one or more multicast broadcast services; one or more discontinuous reception (DRX) parameters for monitoring one or more radio network temporary identifiers (RNTIs) associated with the one or more multicast broadcast services; and a neighbor cell information list indicating one or more neighbor cells for reception of the one or more multicast broadcast services. In some embodiments, the one or more DRX parameters may comprise a first DRX parameter associated with a first multicast broadcast traffic channel and a second DRX parameter associated with a second multicast broadcast traffic channel. In some embodiments, the first DRX parameter may be one or more of a first inactivity timer value and a first on duration timer value. The second DRX parameter may be one or more of a second inactivity timer value and a second on duration timer value.

In some embodiments, the control information may be associated with a multicast broadcast control logical channel.

In some embodiments, the one or more BWPs are associated with the one or more numerologies; and the one or more multicast broadcast services are associated with the one or more numerologies.

In some embodiments, the configuration parameters may further indicate: one or more first service identifiers associated with the one or more multicast broadcast service; and the one or more first RNTIs are associated with the first service identifier.

In some embodiments, the one or more messages may comprise one or more radio resource control (RRC) messages.

In some embodiments, the one or more messages may comprise a system information block (SIB) associated with the multicast broadcast services.

In some embodiments, the receiving the one or more messages may be based on a random access procedure for reception of on-demand system information.

In some embodiments, the receiving the one or more messages may be based on a service discovery process indicating one or more multicast broadcast services that are of interest to the UE.

In some embodiments, the UE may receive, during the service discovery process, one or more service identifiers of the one or more multicast broadcast services that are of interest to the UE.

In some embodiments, the receiving the one or more messages may be via a default BWP.

In some embodiments, the receiving the one or more messages may be via a default BWP of a primary cell.

In some embodiments, the receiving the one or more messages may be based on transitioning from an RRC Idle state to an RRC Connected state or transitioning from an RRC Inactive state to an RRC Connected state.

In some embodiments, the transitioning from an RRC Idle state to an RRC Connected state or transitioning from an RRC Inactive state to an RRC Connected state may be based on a service discovery process indicating one or more multicast broadcast services that are of interest to the UE.

In some embodiments, the UE may switch to a first BWP for reception of the one or more broadcast multicast services. The UE may switch to a second BWP after a first time duration from the switching to the first BWP.

In some embodiments, the second BWP may be a default BWP.

In some embodiments, the second BWP may be an active BWP before switching to the first BWP.

In some embodiments, the UE may start a timer based on switching to the first BWP.

In some embodiments, the switching to the second BWP may be based on the timer expiring.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of’ or “one or more of’. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

Clause 1. A wireless communication method comprising: receiving, by a user equipment (UE), one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast services;
receiving, by the UE, downlink control information associated with the one or more first RNTIs; and
receiving, based on the downlink control information, one or more transport blocks associated with the one or more multicast broadcast service.

Clause 2. The wireless communication method of Clause 1, wherein the configuration parameters comprise first configuration parameters of the first CORESET or the first BWP.

Clause 3. The wireless communication method of Clause 1, wherein the one or more transport blocks comprise control information associated with the one or more multicast broadcast services.

Clause 4. The wireless communication method of Clause 1, wherein the configuration parameters further include data indicative of:
one or more first service identifiers associated with the one or more multicast broadcast service; and
one or more first RNTIs associated with the first service identifier.

Clause 5. The wireless communication method of Clause 1, wherein the one or more messages comprise one or more radio resource control (RRC) messages.

Clause 6. The wireless communication method of Clause 1, wherein the one or more messages comprise a system information block (SIB) associated with the multicast broadcast services.

Clause 7. The wireless communication method of Clause 1, wherein receiving the one or more messages is based on a random access procedure for reception of on-demand system information.

Clause 8. The wireless communication method of Clause 1, wherein receiving the one or more messages is based on a service discovery process identifying one or more of the multicast broadcast service.

Clause 9. The wireless communication method of Clause 8 further comprising receiving, during the service discovery process, one or more service identifiers of the one or more multicast broadcast service.

Clause 10. The wireless communication method of Clause 1, wherein the receiving the one or more messages is via a default BWP.

Clause 11. The wireless communication method of Clause 10, wherein the receiving the one or more messages includes receiving the one or more messages via a default BWP of a primary cell.

Clause 12. The wireless communication method of Clause 1, wherein the receiving the one or more messages includes receiving the one or more messages based on at least one of transitioning from an RRC Idle state to an RRC Connected state or transitioning from an RRC Inactive state to an RRC Connected state.

Clause 13. The wireless communication method of Clause 12, wherein the transitioning from an RRC Idle state to an RRC Connected state or transitioning from an RRC Inactive state to an RRC Connected state is based on a service discovery process indicating one or more multicast broadcast services that are of interest to the UE.

Clause 14. The wireless communication method of Clause 1 further comprising:
switching to a first BWP for reception of the one or more broadcast multicast services; and
switching to a second BWP after a first time duration from the switching to the first BWP.

Clause 15. The wireless communication method of Clause 14, wherein the second BWP is a default BWP.

Clause 16. The wireless communication method of Clause 14, wherein the second BWP is an active BWP before switching to the first BWP.

Clause 17. The wireless communication method of Clause 14 further comprising starting a timer based on switching to the first BWP.

Clause 18. The wireless communication method of Clause 17, wherein the switching to the second BWP is based on the timer expiring.

Clause 19. A wireless communication method comprising: receiving configuration parameters of a semi-persistent scheduling (SPS) configuration associated with one or more multicast broadcast services; and
receiving, based on a SPS resource associated with the SPS configuration, one or more transport blocks associated with the one or more multicast broadcast services.

Clause 20. The wireless communication method of Clause 19, wherein the configuration parameters comprise a first identifier indicating that the SPS configuration is associated with the one or more multicast broadcast services.

Clause 21. The wireless communication method of Clause 19 further comprising receiving a downlink control information indicating activation of the SPS configuration.

Clause 22. The wireless communication method of Clause 19, wherein the one or more transport blocks comprise control information associated with the one or more multicast broadcast services.

Clause 23. The wireless communication method of Clause 22, wherein the control information is associated with one or more multicast broadcast control logical channels.

Clause 24. The wireless communication method of Clause 22, wherein the control information indicates at least one of:
one or more service identifiers for the one or more multicast broadcast services;
one or more second RNTIs for reception of downlink data associated with the one or more service identifiers;
one or more numerologies for reception of the one or more multicast broadcast services;
one or more quality of service requirements for the one or more multicast broadcast services;
one or more periodicities associated with the one or more multicast broadcast services;
one or more cell identifiers of one or more cells for reception of the one or more multicast broadcast services; and
a neighbor cell information list indicating one or more neighbor cells for reception of the one or more multicast broadcast services.

Clause 25. The wireless communication method of Clause 22, wherein the control information indicates one or more discontinuous reception (DRX) parameters for monitoring one or more radio network temporary identifiers (RNTIs) associated with the one or more multicast broadcast services.

Clause 26. The wireless communication method of Clause 25, wherein the one or more DRX parameters comprise a first DRX parameter associated with a first multicast broadcast traffic channel and a second DRX parameter associated with a second multicast broadcast traffic channel.

Clause 27. The wireless communication method of Clause 26, wherein the first DRX parameter is one or more of a first inactivity timer value and a first on duration timer value; and the second DRX parameter is one or more of a second inactivity timer value and a second on duration timer value.

Clause 28. The wireless communication method of Clause 22, wherein the control information indicates one or more BWP identifiers of one or more BWPs for reception of the one or more multicast broadcast services.

Clause 29. The wireless communication method of Clause 22, wherein the control information indicates one or more BWP identifiers of one or more BWPs for reception of the one or more multicast broadcast services.

Clause 30. The wireless communication method of Clause 29, wherein the one or more BWPs are associated with the one or more numerologies; and the one or more multicast broadcast service is associated with the one or more numerologies.

Clause 31. An apparatus for utilization in wireless communications comprising:
an antenna for use in transmission of electromagnetic signals;
a memory for maintaining computer-readable code; and
a processor for executing the computer-readable code that causes the apparatus to:
receive one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast services;
receive downlink control information associated with the one or more first RNTIs; and
receive, based on the downlink control information, one or more transport blocks associated with the one or more multicast broadcast service.

Clause 32. The apparatus of Clause 31, wherein the configuration parameters comprise first configuration parameters of the first CORESET or the first BWP.

Clause 33. The apparatus of Clause 31, wherein the one or more transport blocks comprise control information associated with the one or more multicast broadcast services.

Clause 34. The apparatus of Clause 31, wherein the configuration parameters further include data indicative of:
one or more first service identifiers associated with the one or more multicast broadcast service; and
one or more first RNTIs associated with the first service identifier.

Clause 35. The apparatus of Clause 31, wherein the one or more messages comprise one or more radio resource control (RRC) messages.

Clause 36. The apparatus of Clause 31, wherein the one or more messages comprise a system information block (SIB) associated with the multicast broadcast services.

Clause 37. The apparatus of Clause 31, wherein receiving the one or more messages is based on a random access procedure for reception of on-demand system information.

Clause 38. The apparatus of Clause 31, wherein receiving the one or more messages is based on a service discovery process identifying one or more of the multicast broadcast service.

Clause 39. The apparatus of Clause 38 further comprising receiving, during the service discovery process, one or more service identifiers of the one or more multicast broadcast service.

Clause 40. A wireless communication method comprising: transmitting by a radio access node (RAN) one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast services;
transmitting, by the RAN, downlink control information associated with the one or more first RNTIs; and
transmitting, based on the downlink control information, one or more transport blocks associated with the one or more multicast broadcast service.

Clause 41. The wireless communication method of Clause 40, wherein the configuration parameters comprise first configuration parameters of the first CORESET or the first BWP.

Clause 42. The wireless communication method of Clause 40, wherein the one or more transport blocks comprise control information associated with the one or more multicast broadcast services.

Clause 43. The wireless communication method of Clause 40, wherein the configuration parameters further include data indicative of:
one or more first service identifiers associated with the
one or more multicast broadcast service; and
one or more first RNTIs associated with the first service identifier.

Clause 44. The wireless communication method of Clause 40, wherein the one or more messages comprise one or more radio resource control (RRC) messages.

Clause 45. The wireless communication method of Clause 40, wherein the one or more messages comprise a system information block (SIB) associated with the multicast broadcast services.

Clause 46. The wireless communication method of Clause 40, wherein transmitting the one or more messages is based on a random access procedure for reception of on-demand system information.

Clause 47. The wireless communication method of Clause 40, wherein transmitting the one or more messages is based a service discovery process identifying one or more of the multicast broadcast service.

Clause 48. The wireless communication method of Clause 47 further comprising transmitting, during the service discovery process, one or more service identifiers of the one or more multicast broadcast service.

Clause 49. The wireless communication method of Clause 40, wherein transmitting the one or more messages is via a default BWP.

Clause 50. The wireless communication method of Clause 49, wherein transmitting the one or more messages includes transmitting the one or more messages via a default BWP of a primary cell.

Clause 51. The wireless communication method of Clause 40, wherein the transmitting the one or more messages includes transmitting the one or more messages based on at least one of transitioning from an RRC Idle state to an RRC Connected state or transitioning from an RRC Inactive state to an RRC Connected state.

Clause 52. The wireless communication method of Clause 51, wherein the transitioning from an RRC Idle state to an RRC Connected state or transitioning from an RRC Inactive state to an RRC Connected state is based on a service discovery process indicating one or more multicast broadcast services UE.

Clause 53. The wireless communication method of Clause 40 further comprising:
switching to a first BWP for transmission of the one or more broadcast multicast services; and
switching to a second BWP after a first time duration from the switching to the first BWP.

Clause 54. The wireless communication method of Clause 53, wherein the second BWP is a default BWP.

Clause 55. The wireless communication method of Clause 53, wherein the second BWP is an active BWP before switching to the first BWP.

Clause 56. The wireless communication method of Clause 53 further comprising starting a timer based on switching to the first BWP.

Clause 57. The wireless communication method of Clause 55, wherein the switching to the second BWP is based on the timer expiring.

Clause 58. A wireless communication method comprising:
transmitting configuration parameters of a semi-persistent scheduling (SPS) configuration associated with one or more multicast broadcast services; and
transmitting, based on a SPS resource associated with the SPS configuration, one or more transport blocks associated with the one or more multicast broadcast services.

Clause 59. The wireless communication method of Clause 58, wherein the configuration parameters comprise a first identifier indicating that the SPS configuration is associated with the one or more multicast broadcast services.

Clause 60. The wireless communication method of Clause 58 further comprising transmitting a downlink control information indicating activation of the SPS configuration.

Clause 61. The wireless communication method of Clause 58, wherein the one or more transport blocks comprise control information associated with the one or more multicast broadcast services.

Clause 62. The wireless communication method of Clause 61, wherein the control information is associated with one or more multicast broadcast control logical channels.

Clause 63. The wireless communication method of Clause 61, wherein the control information indicates at least one of: one or more service identifiers for the one or more multicast broadcast services;
one or more second RNTIs for reception of downlink data associated with the one or more service identifiers;
one or more numerologies for reception of the one or more multicast broadcast services;
one or more quality of service requirements for the one or more multicast broadcast services;
one or more periodicities associated with the one or more multicast broadcast services;
one or more cell identifiers of one or more cells for reception of the one or more multicast broadcast services; and
a neighbor cell information list indicating one or more neighbor cells for reception of the one or more multicast broadcast services.

Clause 64. The wireless communication method of Clause 61, wherein the control information indicates one or more discontinuous reception (DRX) parameters for monitoring one or more radio network temporary identifiers (RNTIs) associated with the one or more multicast broadcast services.

Clause 65. The wireless communication method of Clause 64, wherein the one or more DRX parameters comprise a first DRX parameter associated with a first multicast broadcast traffic channel and a second DRX parameter associated with a second multicast broadcast traffic channel.

Clause 66. The wireless communication method of Clause 65, wherein the first DRX parameter is one or more of a first inactivity timer value and a first on duration timer value; and the second DRX parameter is one or more of a second inactivity timer value and a second on duration timer value.

Clause 67. The wireless communication method of Clause 61, wherein the control information indicates one or more BWP identifiers of one or more BWPs for reception of the one or more multicast broadcast services.

Clause 68. The wireless communication method of Clause 61, wherein the control information indicates one or more BWP identifiers of one or more BWPs for reception of the one or more multicast broadcast services.

Clause 69. The wireless communication method of Clause 68, wherein the one or more BWPs are associated with the one or more numerologies; and the one or more multicast broadcast service is associated with the one or more numerologies.

Clause 70. An apparatus for utilization in wireless communications comprising:
an antenna for use in transmission of electromagnetic signals;
a memory for maintaining computer-readable code; and
a processor for executing the computer-readable code that causes the apparatus to:
transmit one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast services;
transmit downlink control information associated with the one or more first RNTIs; and
transmit, based on the downlink control information, one or more transport blocks associated with the one or more multicast broadcast service.

Clause 71. The apparatus of Clause 70, wherein the configuration parameters comprise first configuration parameters of the first CORESET or the first BWP.

Clause 72. The apparatus of Clause 70, wherein the one or more transport blocks comprise control information associated with the one or more multicast broadcast services.

Clause 73. The apparatus of Clause 70, wherein the configuration parameters further include data indicative of:

one or more first service identifiers associated with the one or more multicast broadcast service; and

one or more first RNTIs associated with the first service identifier.

Clause 74. The apparatus of Clause 70, wherein the one or more messages comprise one or more radio resource control (RRC) messages.

Clause 75. The apparatus of Clause 70, wherein the one or more messages comprise a system information block (SIB) associated with the multicast broadcast services.

Clause 76. The apparatus of Clause 70, wherein transmitting the one or more messages is based on a random access procedure for reception of on-demand system information.

Clause 77. The apparatus of Clause 70, wherein transmitting the one or more messages is based on a service discovery process identifying one or more of the multicast broadcast service.

Clause 78. The apparatus of Clause 77 wherein the apparatus is further operative to transmit, during the service discovery process, one or more service identifiers of the one or more multicast broadcast service.

This application claims the benefit of U.S. Provisional Application No. 63/073,732, entitled “SYSTEM AND METHOD FOR MAINTAINING MULTICAST BROADCAST SERVICE”, and filed on Sep. 2, 2020. U.S. Provisional Application No. 63/073,732 is incorporated by reference herein.

1-48. (canceled)

49. A wireless communication method comprising:
receiving, by a user equipment (UE), one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast service;
receiving, by the UE, downlink control information associated with the one or more first RNTIs; and
receiving, based on the downlink control information, one or more transport blocks associated with the one or more multicast broadcast service, wherein
the one or more first RNTIs are used to scramble cyclic redundancy check (CRC) bits of the downlink control information indicating activation or deactivation of
semi-persistent scheduling (SPS).

50. The wireless communication method of claim 49, wherein the configuration parameters comprise first configuration parameters of the first CORESET or the first BWP.

51. The wireless communication method of claim 49, wherein the one or more transport blocks comprise control information associated with the one or more multicast broadcast service.

52. The wireless communication method of claim 49, wherein the configuration parameters further include data indicative of:
one or more first service identifier associated with the one or more multicast broadcast service; and
one or more first RNTIs associated with the first service identifier.

53. The wireless communication method of claim 49, wherein the one or more messages comprise one or more radio resource control (RRC) messages.

54. The wireless communication method of claim 49, wherein the one or more messages comprise a system information block (SIB) associated with the one or more multicast broadcast service.

55. The wireless communication method of claim 49, wherein receiving the one or more messages is based on a random access procedure for reception of on-demand system information.

56. The wireless communication method of claim 49, wherein receiving the one or more messages is based on a service discovery process identifying one or more of the multicast broadcast service.

57. The wireless communication method of claim 56, further comprising receiving, during the service discovery process, one or more service identifiers of the one or more multicast broadcast service.

58. The wireless communication method of claim 49, wherein the receiving the one or more messages is via a default BWP.

59. The wireless communication method of claim 58, wherein the receiving the one or more messages includes receiving the one or more messages via a default BWP of a primary cell.

60. A wireless communication method comprising:
transmitting by a radio access node (RAN) one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast service;
transmitting, by the RAN, downlink control information associated with the one or more first RNTIs; and
transmitting, based on the downlink control information, one or more transport blocks associated with the one or more multicast broadcast service, wherein
the one or more first RNTIs are used to scramble cyclic redundancy check (CRC) bits of the downlink control information indicating activation or deactivation of
semi-persistent scheduling (SPS).

61. The wireless communication method of claim 60, wherein the configuration parameters comprise first configuration parameters of the first CORESET or the first BWP.

62. The wireless communication method of claim 60, wherein the one or more transport blocks comprise control information associated with the one or more multicast broadcast service.

63. The wireless communication method of claim 60, wherein the configuration parameters further include data indicative of:
one or more first service identifier associated with the one or more multicast broadcast service; and
one or more first RNTIs associated with the first service identifier.

64. The wireless communication method of claim 60, wherein the one or more messages comprise one or more radio resource control (RRC) messages.

65. The wireless communication method of claim 60, wherein the one or more messages comprise a system information block (SIB) associated with the one or more multicast broadcast service.

66. The wireless communication method of claim 60, wherein the one or more messages are received based on a random access procedure for reception of on-demand system information.

67. The wireless communication method of claim 60, wherein the one or more messages are received based on a service discovery process identifying one or more of the multicast broadcast service.

68. The wireless communication method of claim 67, further comprising transmitting, during the service discovery process, one or more service identifiers of the one or more multicast broadcast service.

69. The wireless communication method of claim 60, wherein the transmitting the one or more messages is via a default BWP.

70. The wireless communication method of claim 69, wherein the transmitting the one or more messages includes transmitting the one or more messages via a default BWP of a primary cell.

71. A user equipment (UE) comprising:
receiving circuitry configured to receive one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast service,
the receiving circuitry being configured to receive downlink control information associated with the one or more first RNTIs, and
the receiving circuitry being configured to receive, based on the downlink control information, one or more transport blocks associated with the one or more multicast broadcast service, wherein
the one or more first RNTIs are used to scramble cyclic redundancy check (CRC) bits of the downlink control information indicating activation or deactivation of
semi-persistent scheduling (SPS).

72. A radio access node (RAN) comprising:
transmitting circuitry configured to transmit one or more messages comprising:
configuration parameters indicating that one or more multicast broadcast service is associated with at least one of:
a first control resource set (CORESET); and
a first bandwidth part (BWP); and
one or more first radio network temporary identifiers (RNTIs) associated with the one or more multicast broadcast services,
the transmitting circuitry being configured to transmit downlink control information associated with the one or more first RNTIs, and
the transmitting circuitry being configured to transmit, based on the downlink control information, one or more transport blocks associated with the one or more multicast broadcast service, wherein
the one or more first RNTIs are used to scramble cyclic redundancy check (CRC) bits of the downlink control information indicating activation or deactivation of
semi-persistent scheduling (SPS).
